(19) United States
(12) Patent Application Publication
(10) Pub. No.: US 2026/0251440 A1
(43) Pub. Date: Aug. 27, 2026

(54) DEVICE FOR GUIDING MEASURING LIGHT TO BE SPECTRALLY ANALYZED, METHOD FOR MANUFACTURING SUCH A DEVICE, AND APPARATUS FOR MEASURING DISTANCE AND THICKNESS

(71) Applicant: MICRO-EPSILON Optronic GmbH, Langebrueck (DE)

(72) Inventor: Peter Meja, Dresden (DE)

(21) Appl. No.: 18/879,469

(22) PCT Filed: Jun. 26, 2023
(86) PCT No.: PCT/DE2023/200128

§ 371 Date: Dec. 27, 2024

(30) Foreign Application Priority Data
Jun. 30, 2022 (DE) 10 2022 206 728.2

(51) Int. Cl. G01B 11/06; G01C 3/02

(52) U.S. Cl. CPC G01B 11/06; G01C 3/02

(57) ABSTRACT

A device for guiding measuring light to be spectrally analyzed in a distance and/or thickness measuring system, in particular in a confocal-chromatic or interferometric distance and/or thickness measuring system, includes an optical waveguide wherein the optical waveguide has an exit end preferably held by a ferrule, for the measuring light, is and an aperture having an aperture opening that is arranged on the exit end Furthermore, a method for manufacturing such a device, and an apparatus for distance and/or thickness measurement, are described.

### BACKGROUND

### Technical Field

The present disclosure relates to a device and an apparatus for distance and/or thickness measurement, in particular for interferometric and/or confocal-chromatic distance and/or thickness measurement.

The disclosure moreover relates to a method for manufacturing a device according to the disclosure.

Description of the Related ArtBoth confocal-chromatic and interferometric distance and thickness measuring systems are known from the prior art, in which the measuring light to be spectrally analyzed is coupled into a spectrometer by means of multimodal optical waveguides. The end of the usually circular fibers also takes on the function of a (point) aperture for the light that is divergently coupled out of the fiber. The spectral image, modified with a dispersive optical element, of this fiber end is ultimately imaged on a row or multi-row detector. The active surfaces (pixels) of the detectors are usually square and, in the case of particularly sensitive row detectors, also rectangular, wherein in this case the height of the individual active cell is greater than the distance between the pixels, also called the pixel pitch.

Such measuring systems are subject to the constant requirement to increase the measuring speed and the distance resolution as well as to have a high resolution of the distances between two or more layers at the same time for layer thickness measurements. In addition to using more sensitive detectors that can be read more quickly, it is important to provide as much measuring light as possible with a good signal-to-noise ratio in order to increase speed.

To improve the absolute distance resolution for a single measuring object or target or a layer within a defined measuring range, it is sufficient for confocal-chromatic measuring systems to scan the spectrum to be analyzed with a sensor with a higher pixel density. This means that more measuring points are available for the analog-to-digital conversion, which ultimately enables a more stable signal analysis and center of gravity determination. When measuring only one distance, the pixel-related peak width in the spectrogram is initially of little interest. However, if the distance between two closely spaced reflections in the spectrogram is to be resolved with sufficient accuracy when measuring the thickness of a material, the pixel-related width of the individual measurement peaks must be reduced in order to delay signal superposition as long as possible through steep signal edges when the distance is reduced. The reason lies in the summation of the individual peaks during superposition, which ultimately leads to a merging of the individual signals and associated analytical inseparability.

In the interferometric measurement method, a narrower peak leads to a higher degree of modulation of high frequencies, and thus the distance resolution is also significantly improved.

According to this finding, in order to improve the resolution of the distance between two closely spaced reflections, the image of the fiber on the spectrometer row would have to be reduced in size. This can be achieved by using a smaller fiber. However, this type of improvement in spectral sharpness is accompanied by a significant loss of intensity of the measuring light, since the other fiber end on the light source side can capture less light. This ultimately leads to longer exposure times and the resulting lower measurement frequencies.

Another possibility for reducing the beam diameter on the row without major light losses is to reduce the image of the fiber end on the detector row by appropriately designing the optics that are already necessary anyway. However, this option is disadvantageous because the disadvantages clearly outweigh the advantages due to the higher requirements for correcting the imaging errors of these optics, in particular for the higher field angles of a necessarily more strongly dispersive, spectrally decomposing element. These disadvantages include an increased space requirement and increased weight due to the more complex optics, as well as significantly higher costs for manufacturing these optics.

A solution that initially appears promising would be to taper the fiber end that ends in the spectrometer by means of a fiber drawing process under the influence of heat. However, considered more closely, with a constant light source, only a smaller solid angle is transferred here from the light source side to the detector surface. This does make the light spot smaller, but, at the same time, its overall intensity is reduced because only a smaller region of the light source is captured. Ultimately, the reduction in peak width is also accompanied by a disadvantageous loss of intensity.

Furthermore, reference is made to document WO 2021/255584 A1, by way of example only. This document describes an optical measuring apparatus for measuring distances and/or thicknesses of a measured object. The optical measuring apparatus comprises a measuring head with imaging optics and an evaluation unit, wherein the measuring head is connected to the evaluation unit by two light-conducting fibers. The evaluation unit comprises a light source whose light is guided into the measuring head through the first light-conducting fiber. Light reflected from the measuring object is guided back through the measuring head and by means of a beam splitter into a second light-conducting fiber in such a way that the outgoing and returning light are separated, with the fiber ends in conjugated position to each other. Furthermore, a separate aperture arrangement is formed in front of the ends, facing the measured object, of the light-conducting fibers. These aperture arrangements must be positioned extremely precisely in all three spatial directions and then fixed. Therefore, the adjustment is extremely complex and the mechanical and thermal stability is low due to the individual components that have to be connected.

### BRIEF SUMMARY AND GENERAL DESCRIPTION

The present disclosure is directed to a device for guiding measuring light to be spectrally analyzed in such a way that, using structurally simple means, as much measuring light as possible is provided with a good signal-to-noise ratio. Furthermore, a method for manufacturing such a device is to be specified. Furthermore, an improved apparatus for distance and/or thickness measurement is to be specified.

According to the disclosure, a device for guiding measuring light to be spectrally analyzed in a distance and/or thickness measuring system, in particular in a confocal-chromatic or interferometric distance and/or thickness measuring system, includes an optical waveguide, wherein the optical waveguide has an exit end, preferably held by a ferrule, for the measuring light. The device is characterized in that an aperture with an aperture opening is arranged on the exit end.

With regard to the apparatus, disclosed herein is an apparatus for distance and/or thickness measurement, in particular for interferometric and/or confocal-chromatic distance and/or thickness measurement, with a device for guiding measuring light as described herein and a spectrometer, having a detector, for evaluating the measuring light, wherein the exit end of the optical waveguide, which exit end has the aperture with the aperture opening, is arranged in and/or on the spectrometer.

The device according to the disclosure provides a significant increase in light output, because the diameter of the optical waveguide, in particular a fiber diameter, is significantly increased while maintaining the same spectral selectivity, and thus a significantly larger amount of light can be processed in the measuring system. This ultimately results in a significant increase in the possible measurement frequency even on materials with low reflectivity. This is particularly important when used in an apparatus with a rectangular detector row geometry with pixel aspect ratios (PAR) significantly below 1, so that the apparatus according to the present disclosure can advantageously have such a detector. A further advantage is that a higher selectivity can be achieved compared to a system with an optical waveguide not having an aperture. The selectivity of a detector, in particular of a spectrometer, refers to the ability to clearly distinguish two closely spaced maxima of a continuous spectrum by means of a spatially discrete sampling. In accordance with the present disclosure, a significantly higher selectivity can be achieved in the spectrometer, since the width of the light source image can be adapted to the aspect ratio of the row by means of the, in particular lateral, action of the aperture. In distance measurement systems, increasing the selectivity in an otherwise identical system ultimately means improving the distance resolution. The aperture can be applied directly to the exit end or arranged on it in any way. A further advantage is the variable light output, since, by adjusting the size of the aperture opening-in addition to changing the light source intensity—it is possible to respond to different required light outputs for particular measuring tasks. In this case, it is sufficient to use an optical waveguide with a different aperture geometry.

In addition, the teaching according to the present disclosure is characterized by a particularly simple positionability of the aperture opening. The positioning of the aperture opening relative to the optical waveguide, in particular in relation to a fiber core, can be achieved by an easily automated process with a very high repeatability, in particular if the exit end of the optical waveguide or fiber is embedded in a ferrule, which preferably has a center position tolerance of <1 μm. Furthermore, it is conceivable and advantageous for the exit end of the optical waveguide or fiber to have a circular cross-section. A further advantage is that, by arranging the aperture at the exit end of the optical waveguide, the waveguide is suitable for being arranged, not in a measuring head, but in a spectrometer. Such a construction is realized by the apparatus according to the present disclosure. Compared to an arrangement of the aperture on the measuring head side, this has the further advantage that the aperture has no influence on the projection of the measuring light onto the measured object, but exclusively on the projection of the light, in particular the spectrally decomposed light, onto the detector or a detector row. Thus, the aperture improves only the spectral resolution.

Advantageously, the aperture opening is designed as a slit. In other words, the effective opening has an elongated, narrow geometry. The elongated sides of the aperture opening can, in a further advantageous manner, run at least substantially parallel to one another. This makes it possible to adapt the image of the optical waveguide to the geometry of the pixels of a downstream detector. In a further advantageous manner, the detector of the apparatus according to the disclosure can be designed as a row detector or as a multi-row detector. Such a detector may have square or rectangular pixels, in particular with a pixel aspect ratio PAR=xₚ/yₚ=pixel width/pixel height in the range of 1/40 to 1/20. A slit-shaped aperture opening allows the active surface of a row or multi-row detector to be better utilized.

In a further advantageous manner, the aperture opening can have a shape other than a rectangle; in particular, it can be cushion-shaped, barrel-shaped, lens-shaped, or oval. In one embodiment, the aperture opening can be ideally adapted to a detector so that an improved signal-to-noise ratio can be achieved. Alternatively or additionally, perforation openings could be formed on the aperture. Such a perforation can be realized in particular as a micro-perforation and generally has the advantage that the edge sharpness of the aperture image on the detector can be varied, and thus the shape of the peak tip can be adapted to the requirements of the measuring system. Such an effect could also be achieved by making the aperture partially transparent, at least in the edge region of the aperture opening.

According to an advantageous embodiment, the aperture opening can have a beveled edge at least in some regions. If the material of the aperture is not completely optically tight or is partially transparent, this can be used to achieve a softer edge profile when the aperture is imaged onto the detector. This creates a similarly advantageous effect as with an aperture made of a partially transparent material.

Advantageously, the aperture can be formed by a coating, e.g., made of a lacquer, which coating is applied to the exit end and is partially transparent or non-transparent to the measuring light. This makes effective aperture action possible in a particularly simple way. The coating can be partially removed by microablation, laser ablation, or mechanically to form the aperture opening. Furthermore, it is conceivable that the partially transparent or non-transparent coating be printed on the exit end. Thus, the shape of the aperture opening and possibly other configurations such as a perforation can already be created by the printed image.

According to a further advantageous embodiment, the aperture can be formed by a chrome coating printed on the exit end. A photochemical lacquer can be applied to the chrome coating, which lacquer has been exposed in a targeted manner through a mask corresponding to the aperture or the aperture opening and possibly other configurations, and the aperture opening has been etched free.

In a further advantageous manner, the aperture opening can extend at least partially over a fiber core and at least partially over a fiber cladding of the optical waveguide.

In a particularly advantageous manner, the optical waveguide can have a multimode fiber, preferably a graded-index fiber or a step-index fiber. Such a fiber is ideal for conducting light that is to be spectrally analyzed.

According to an advantageous embodiment, the optical waveguide and/or the aperture can be aligned such that the measuring light passing through the aperture strikes the detector obliquely to a direction of extension of a detector pixel. In other words, the image of the exit end of the optical waveguide can be rotated with respect to the detector pixel(s) in order to improve the intensity profile detected by the detector pixels. This enables particularly effective adaptation to the detector, in particular for special measuring tasks.

Further disclosed is a method for manufacturing a device as described herein, wherein a partially transparent or non-transparent coating is applied to the exit end of the optical waveguide and wherein the aperture opening is created by partial removal of the coating.

First, it is to be noted that the device according to the present disclosure and the apparatus according to the present disclosure can also be embodied as a method. The corresponding features and associated advantages can expressly be part of the method according to the disclosure. Furthermore, the features and advantages described with respect to the method according to the disclosure can also be part of the device according to the disclosure and the apparatus according to the disclosure.

The teaching according to the present disclosure relates to the, in particular direct, application of an aperture to the exit end, preferably held by a ferrule, of an, in particular ground, multimodal, optical waveguide. In particular, when the optical waveguide is surrounded by a precisely centered ferrule, the aperture can be applied to the exit end with high precision and high repeatability. Various methods are possible for this.

In an advantageous embodiment, a partially transparent or non-transparent coating is first applied to the exit end, and the aperture opening is then exposed using a laser ablation process. A great advantage here is that the procedure can be applied very flexibly, since no masks are required. In addition, the previously applied layer can also be made partially transparent locally by gradual removal or micro-perforation in order to thus influence the drop in intensity in the edge region of the aperture or of the aperture opening for the imaging.

In a further advantageous embodiment, the aperture can be printed on the exit end. In particular, when the optical waveguide is surrounded by a ferrule, extremely precise positioning can be achieved by printing, and printing technology is a very flexible process.

In a further advantageous manner, a lithography method can be used to create the aperture. Here, first a chrome layer is applied to the exit end, a photochemical lacquer applied on top is partially exposed through a mask, and the aperture opening is etched free. Here, too, an individual aperture shape can be achieved.

Overall, the following advantages can be achieved by the teaching according to the disclosure or individual advantageous embodiments described above:

More flexible component selection: The challenge in designing a detector or spectrometer lies in the fact that, in this extremely dynamic market segment, few components conform to a standard. For example, there are rarely row detectors with identical pixel pitch and pixel aspect on the market, with the result that every component discontinuation or change means complex and costly changes in the optical design. Due to the very simple adaptability of the aperture geometry, e.g., through the laser ablation method, it is possible to react flexibly to minor changes to a limited extent, and, for example, different diameters of optical waveguides and rows with different pixel pitches as well as different pixel heights can be adapted to one another very individually without having to fundamentally change the optical design.

Fine adjustment of the edge steepness: Since the aperture can be applied directly to the exit end of an optical waveguide, e.g., a fiber, it is, firstly, possible to design the shape of the aperture opening as desired (oval, rectangular, cushion-shaped, . . . ) and, secondly, the thickness or microstructure of the applied layer can be influenced in order to, for example, reduce the edge sharpness of the image. This has the advantage that the intensity peak in the spectrogram can be very narrow, but cannot fall into the error situation of undersampling by the row. A further advantage of a directly applied aperture is the possibility of adjusting an aperture opening preferably slit-shaped—on the exit end in its alignment with the detector row, e.g., by rotating it, and thus also influencing the edge sharpness of the image with fine adjustment.

Simple optical design: Since the teaching of the disclosure makes it possible to dispense with a significant reduction in the optical image scale, significant cost, space, and weight increases are avoided. In addition, a flexible aperture provides more freedom in optical design or the possibility of optimizing other parameters.

Greater flexibility: The simple manufacture of the aperture, in particular by laser ablation, makes it possible to respond extremely flexibly to different requirements for the aperture, such as the shape of the aperture opening. For example, changes in other elements of the apparatus, e.g., in a dispersion element, in the aperture of the optical waveguide or the diameter of the optical waveguide or, on the row side, in the pixel height or the pixel pitch of the detector, may require an adjustment of the aperture. Likewise, special shapes such as a cushion-shaped aperture opening can also be easily created.

Better stability: With regard to long-term stability, the application of the aperture to the exit end is particularly advantageous, since dynamic force and temperature influences in particular cannot impair the exact aperture positioning, in contrast to a separately arranged aperture.

No loss of aperture: With an aperture applied directly to the exit end, the available aperture can be fully utilized if the coating is sufficiently thin. When arranging a separate aperture, a possible air gap between the fiber end and the aperture would result in part of the available aperture remaining unused due to cutting off the higher exit angles.

### BRIEF DESCRIPTION OF THE SEVERAL VIEWS OF THE DRAWINGS

There are various possibilities for designing and developing the teaching of the present disclosure in an advantageous manner. In this regard, with the aid of the drawings, reference is made, on the one hand, to the dependent claims and, on the other, to the following explanation of preferred exemplary embodiments of the disclosure. In connection with the explanation of the preferred exemplary embodiments of the disclosure based upon the drawings, generally preferred embodiments and developments of the teaching are also explained. In the drawings:

FIG. 1 shows a schematic representation of the image of an exit end on a row detector with an elongated pixel arrangement and the associated continuous intensity profile as a function of the pixel position,

FIG. 2 shows a schematic representation of the image of another exit end on a row detector with an elongated pixel arrangement and the associated continuous intensity profile as a function of the pixel position,

FIG. 3 shows a schematic representation of the image of another exit end on a row detector with an elongated pixel arrangement and the associated continuous intensity profile as a function of the pixel position,

FIG. 4 shows a schematic representation of the image of another exit end on a row detector with an elongated pixel arrangement and the associated continuous intensity profile as a function of the pixel position,

FIG. 5 shows a schematic representation of an exemplary embodiment of the exit end of the light guide of a device according to the present disclosure,

FIG. 6 shows a schematic representation of another exemplary embodiment of the exit end of the light guide of a device according to the present disclosure,

FIG. 7 shows a schematic representation of another exemplary embodiment of the exit end of the light guide of a device according to the present disclosure,

FIG. 8 shows a schematic representation of another exemplary embodiment of the exit end of the light guide of a device according to the present disclosure,

FIG. 9 shows a schematic representation of another exemplary embodiment of the exit end of the light guide of a device according to the present disclosure, and

FIG. 10 shows a schematic representation of an exemplary embodiment of an apparatus according to the present disclosure.

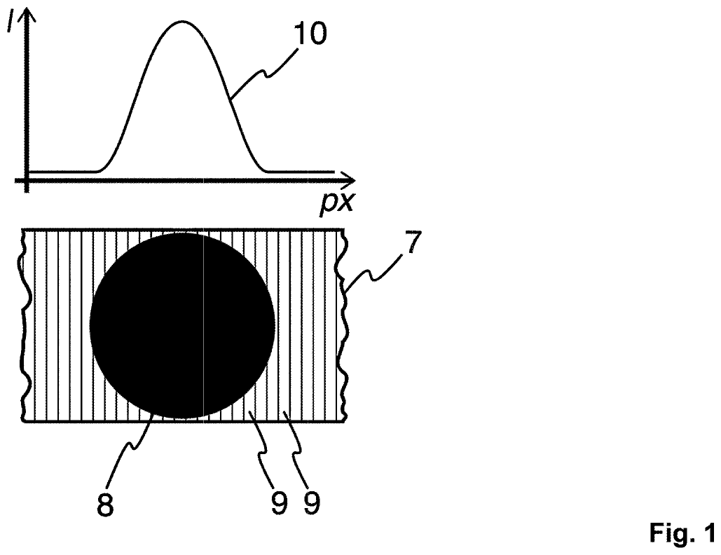

FIGS. 1 to 4 show, by way of example, the beam images 8 of different types of apertures falling on a row detector 7 and their intensity profiles 10 received by the row. For the sake of simplicity, the intensity profiles 10 are shown in continuous form and not in a step profile corresponding to the discrete sampling.

### DETAILED DESCRIPTION

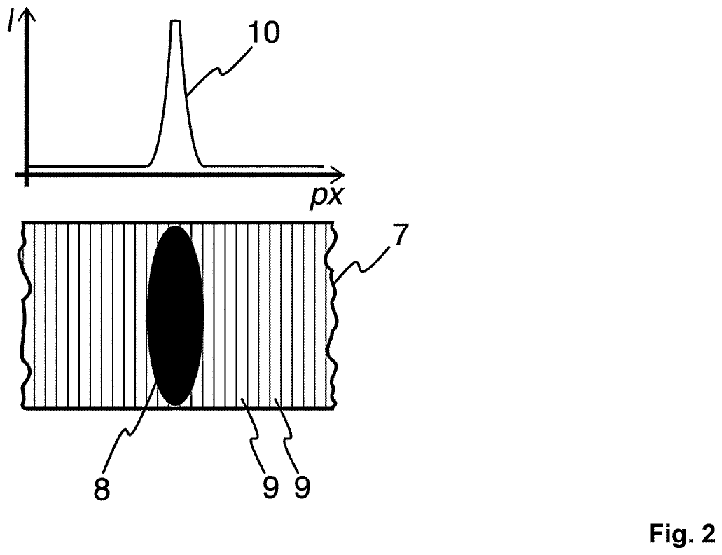

FIG. 1 shows a row detector 7 with narrow detector pixels 9 arranged upright next to one another. The circular beam pattern 8 fills almost the entire row height, whereby the detector 7 processes the entire available amount of radiation. In order to reduce the peak width, the “natural” point aperture of the optical waveguide 11 is now apertured with an additional aperture 1 in a manner according to the disclosure, in order to bring the image of the optical waveguide 11 closer to the pixel geometry. In FIG. 2, such an aperture action with the corresponding intensity profile 10 is shown as an example. It also becomes clear that, when suitably designed, the intensity of the peak maximum, which is crucial for the exposure time, remains unchanged by the lateral aperture action, and the light losses caused by the aperture 1 serve only to intentionally narrow the peak base.

FIG. 1 shows the idealized profile of a gradient index fiber. The point spread function has a Gaussian-like distribution and extends over a large number of indicated elongated detector pixels 9. This profile is much too broad for use in the spectrometer of a confocal-chromatic or interferometric distance measuring device, since two or more closely spaced distances would produce an inseparable superposition of the separate measurement peaks.

Providing the exit end 12 of the optical waveguide 11 with an aperture 1 having a slit-shaped aperture opening 4 as shown in FIG. 2 would produce a very narrow measurement peak which reaches only a few pixel surfaces. However, if the beam profile is too narrow, there are a number of disadvantages. On the one hand, in order to achieve subpixel resolution in the confocal measurement method, the illumination of multiple pixels with sufficient signal-to-noise ratio is indispensable for a stable determination of the center of gravity. On the other hand, detector rows have inactive surface regions between the pixels that should not be underestimated, whereby the risk of drops in intensity during detection increases as the signal width decreases. In extreme cases, in the confocal method, this can lead to signal loss, whereas, in the interferometric method, it can lead to artifact formation due to the imposition of an additional oscillation on the measurement signal.

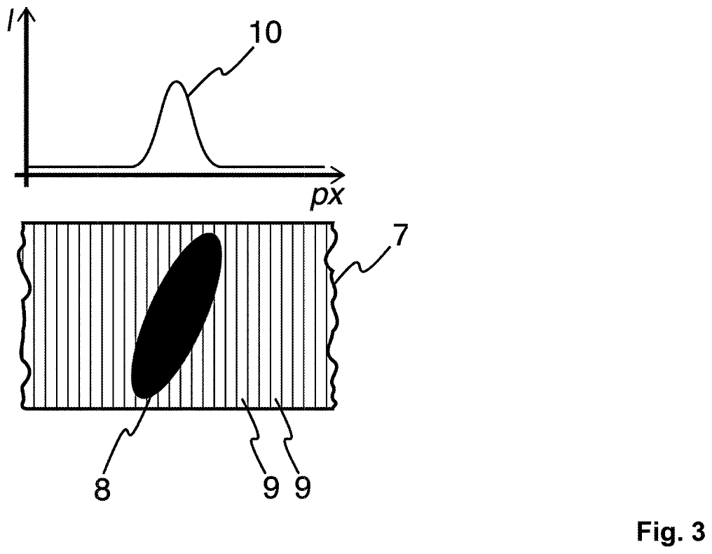

Therefore, the ideal width of an aperture opening 4 depends upon the model-specific pixel pitch of the row detector 7 and the ratio of active to inactive surfaces, as well as the specific requirement for the spectral resolution. The manufacturing and adjustment tolerances in the width of the aperture opening 4, in the numerical aperture of the optical waveguide 11, and in the optics installed in the spectrometer cause a variance in the intensity distribution of the optical waveguide 11 imaged onto the detector pixels 9. Since the aperture 1 is directly connected to the exit end 12 and is also usually embedded in a round ferrule, it is possible to rotate this image of the exit end 12 in relation to the detector pixels 9 and thus to influence the intensity profile 10 detected by the detector pixels 9 (cf. FIG. 3). Due to the rotation, the base of the peak is slightly widened, and thus more pixels are required for the scanning, which leads, among other things, to a more reliable determination of the position of the center of gravity in the confocal measurement method. The width of the peak in the region of the tip does not increase as quickly as the peak rises from the background.

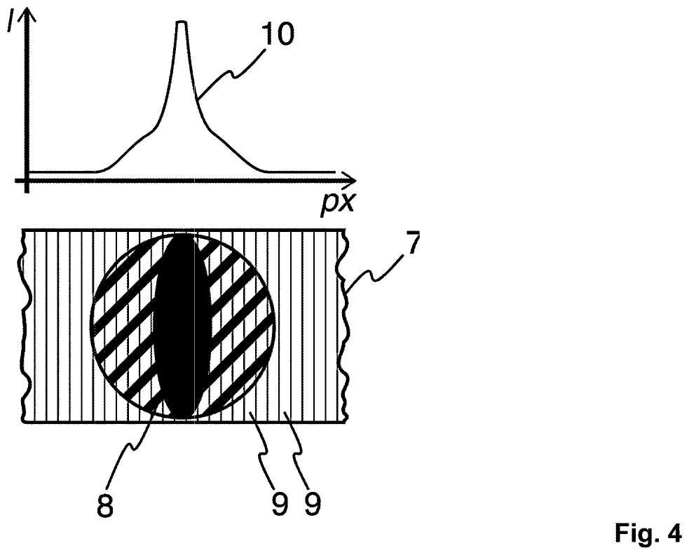

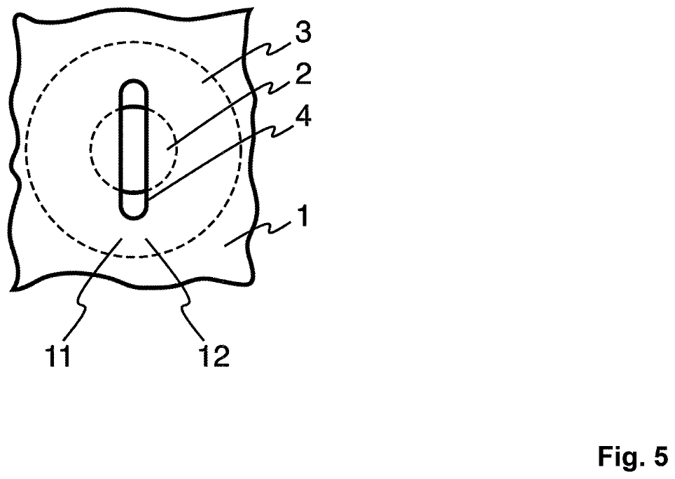

Another possibility for using a sufficient number of pixels for pixel position determination while still achieving a particular weighting of the peak tip is to use a partially transparent layer material for the aperture 1 (cf. FIG. 4). This creates a bell shape several pixels wide that stands out from the background. The exact positioning is maintained due to the nonetheless narrow peak tip. A similar effect can also be achieved through perforation openings 6 of the aperture 1—for example, by means of laser ablation. The manufacturing processes presented enable a precise production of various aperture shapes, some of which are shown as examples in FIGS. 5 to 9.

FIG. 5 shows an aperture 1 with an aperture opening 4, which is designed as a parallel slit and is applied to the exit end 12 of an optical waveguide 11. As a result of the manufacturing, the simple parallel slot can expose not only the fiber core 2 but also the fiber cladding 3. This ensures that the full available aperture is used for the slit height.

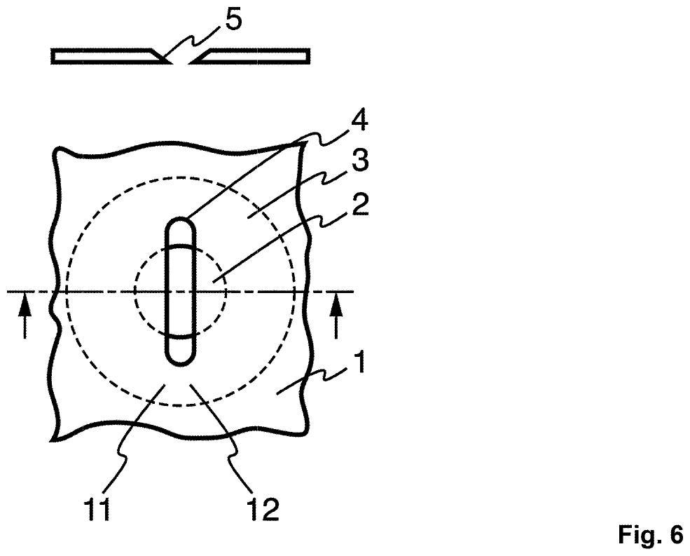

FIG. 6 shows an aperture 1 with a beveling 5 at the edges of the aperture opening 4. If the aperture material is not completely optically tight, a gap edge thinned in this way can lead to a softer edge image—an effect similar to that shown in FIG. 4. When forming the aperture opening 4 by means of laser ablation, the edge can also be caused by the laser beam.

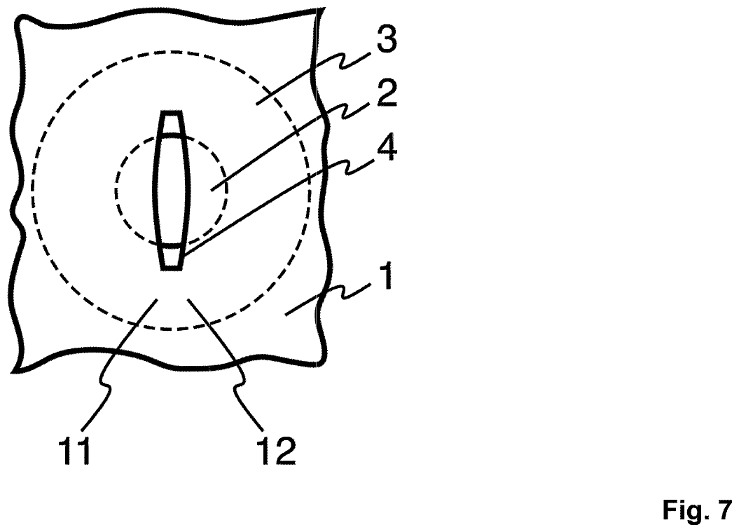

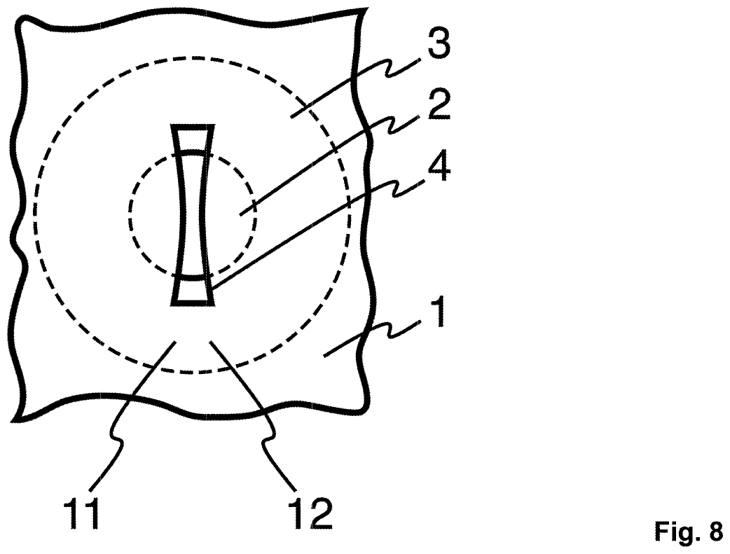

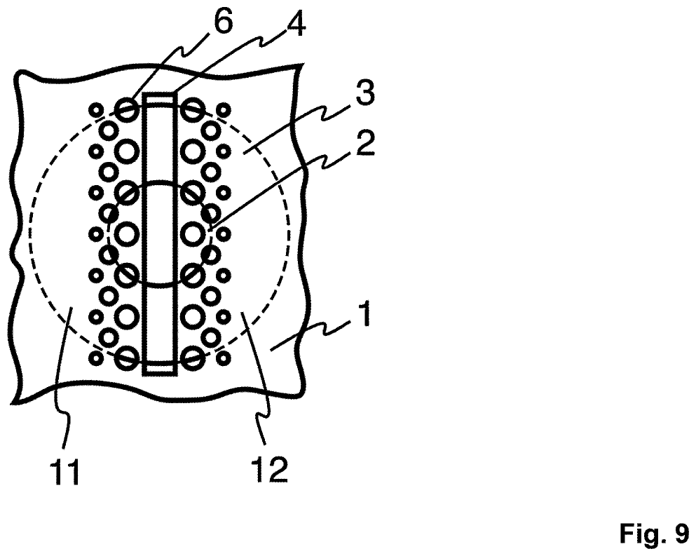

An advantageous design of the aperture opening 4 can also have a barrel shape (cf. FIG. 7) or cushion shape (cf. FIG. 8). It is also possible to produce the sharpness of the edge of the aperture opening 4 or the optical tightness of the aperture 1 by a perforation 6 or micro-perforation, as shown in FIG. 9.

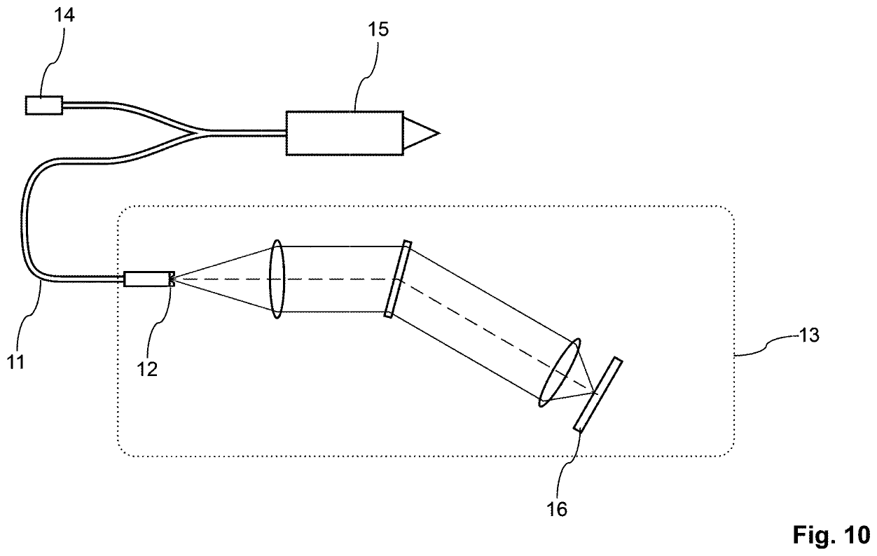

FIG. 10 shows an exemplary embodiment of an apparatus according to the disclosure. This apparatus has a device according to the disclosure for introducing measuring light, as shown for example in FIGS. 1 to 9 described above. It is essential here that the exit end 12 of the optical waveguide 11, which has the aperture 1, is arranged in or on the spectrometer 13. Thus, the aperture 1 has no influence on the projection of the measuring light onto the measuring object.

The function of the apparatus is as follows. The illumination light is directed from a light source 14 via a part of a light wave coupler and a lens 15 onto a measured object (not shown). The measuring light is coupled from the measured object via the lens 15 into the optical waveguide 11 of the optical wave coupler. Via the exit end 12, arranged in the spectrometer 13, of the optical waveguide 11, the measuring light is guided, possibly via further optical elements, onto the detector 16, which in this exemplary embodiment is designed as a row detector. In the exemplary embodiment shown here, the optical waveguide 11 is part of an optical wave coupler, which is formed from the paths light source to coupling point, coupling point to/from lens, and coupling point to spectrometer (optical waveguide 11). The coupling point could also be formed by a beam splitter (cube). The path between the coupling point and the lens also does not necessarily have to be formed, i.e., the common outward and return path can be omitted. The optical waveguide 11 of the embodiment shown here could be designed as a fiber fusion or fiber grinding coupler. It is expressly noted that the beam path of the illumination light and of the measuring light can also be designed differently; the only essential thing is that the exit end 12 of the optical waveguide 11 is arranged on the spectrometer side.

With regard to further advantageous embodiments of the device according to the present disclosure, reference is made to the general part of the description and to the appended claims in order to avoid repetitions.

Finally, it is expressly pointed out that the exemplary embodiments described above of the device according to the disclosure serve only to explain the claimed teaching, but do not limit it to the exemplary embodiments.

### LIST OF REFERENCE SIGNS

1 Aperture
2 Fiber core
3 Fiber cladding
4 Aperture opening
5 Bevel
6 Perforation openings
7 Row detector
8 Beam pattern
9 Detector pixels
10 Intensity profile
11 Optical waveguide
12 Exit end
13 Spectrometer
14 Light source
15 Lens
16 Detector

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A device for guiding measuring light to be spectrally analyzed in a distance and/or thickness measuring system, comprising:
an optical waveguide, wherein the optical waveguide has an exit end for the measuring light, and
an aperture with an aperture opening arranged on the exit end.

2. The device according to claim 1, wherein the aperture opening is a slit.

3. The device according to claim 1, wherein the aperture opening has a shape differing from a rectangle, which is cushion-shaped, barrel-shaped, lens-shaped, or oval.

4. The device according to claim 1, further comprising perforation openings on the aperture.

5. The device according to claim 1, wherein the aperture opening has a beveled edge at least in some regions.

6. The device according to claim 1, wherein the aperture is partially transparent at least in an edge region of the aperture opening.

7. The device according to claim 1, wherein the aperture includes a coating applied to the exit end that is partially transparent or non-transparent to the measuring light.

8. The device according to claim 7, wherein the coating is partially removed by way of microablation, laser ablation, or mechanically to form the aperture opening.

9. The device according to claim 1, further comprising a chrome coating printed on the exit end to form the aperture.

10. The device according to claim 9, wherein a photochemical lacquer is arranged on the chrome coating, which photochemical lacquer is partially exposed, and the aperture opening is formed by etching.

11. The device according to claim 1, wherein the aperture opening extends at least partially over a fiber core and at least partially over a fiber cladding of the optical waveguide.

12. The device according to claim 1, wherein the optical waveguide has a multimode fiber.

13. An apparatus for distance and/or thickness measurement, comprising:
a device for guiding measuring light according to claim 1; and
a spectrometer, having a detector for evaluating the measuring light,
wherein the exit end of the optical waveguide is arranged in and/or on the spectrometer.

14. The apparatus according to claim 13, wherein the detector is a row detector or a multi-row detector.

15. The apparatus according to claim 13, wherein the optical waveguide and/or the aperture is/are aligned such that the measuring light passing through the aperture strikes the detector obliquely to a direction of extension of a detector pixel of the detector.

16. A method for manufacturing a device according to claim 1, comprising:
applying, to the exit end of the optical waveguide, a coating which is partially transparent or non-transparent to the measuring light; and
creating the aperture opening by partial removal of the coating.

17. The device according to claim 1, wherein the distance and/or thickness measuring system is a confocal-chromatic distance and/or thickness measuring system.

18. The device according to claim 1, wherein the distance and/or thickness measuring system is an interferometric distance and/or thickness measuring system.

19. The device according to claim 1, wherein the exit end of the optical waveguide is held by a ferrule.

20. The deice according to claim 12, wherein the multimode fiber is a graded-index fiber or a step-index fiber.
